(19) United States
(12) Patent Application Publication
(10) Pub. No.: US 2006/0008091 A1
(43) Pub. Date: Jan. 12, 2006

(54) Apparatus and method for cross-talk cancellation in a mobile device

(75) Inventors: Jae-Hyun Kim, Suwon-si (KR); Sang-Ki Kang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/174,469

(22) Filed: Jul. 6, 2005

(30) Foreign Application Priority Data
Jul. 6, 2004 (KR) 10-2004-0052328

(51) Int. Cl. H04R 5/00

(52) U.S. Cl. 381/17; 381/1

(57) ABSTRACT

An apparatus and method for eliminating cross-talk being heard at a listener device in a mobile communication system. The apparatus eliminates cross-talk occurring in a signal output through at least two speakers in a mobile system, and includes a decoder for decoding an input signal, a controller for providing information about a delay time difference between direct sound and cross-talk sound of the input signal and gain variation information, a cross-talk cancellation unit for receiving the delay time difference information and the gain variation information and eliminating cross-talk from the decoded signal received from the decoder, and an output unit for converting a stereo signal, from which the cross-talk has been eliminated, into an analog signal and outputting the analog signal through the at least two speakers.

### CROSS-REFERENCE TO RELATED APPLICATIONS

This application claims the benefit under 35 U.S.C. §119(a) of Korean Patent Application No. 10-2004-0052328, entitled “Apparatus And Method For Cross-Talk Cancellation In A Mobile Device”, filed in the Korean Intellectual Property Office on Jul. 6, 2004, the entire disclosure of which is incorporated herein by reference.

### BACKGROUND OF THE INVENTION

1. Field of the Invention

The present invention relates generally to an apparatus and method for listening to a sound signal in a mobile communication system. More particularly, the present invention relates to an apparatus and method for eliminating cross-talk being heard at a listener device.

2. Description of the Related Art

Cross-talk is the phenomenon of interference between sound signals output from at least two speakers. For example, when stereo sound signals are output using two speakers, a sound signal output from the left speaker is heard at a listener's right ear as well as the left ear, and a sound signal output from the right speaker is also heard at the listener's left ear.

As described above, sound from the left speaker being heard at the listener's right ear or sound from the right speaker being heard at the listener's left ear is referred to as a form of cross-talk. Accordingly, cross-talk cancellation is essential to provide a listening system using an earphone. That is, the ideal listening environment is where the sound signal output from the left speaker is heard only at the listener's left ear, and the sound signal output from the right speaker is heard only at the listener's right ear.

This cross-talk must be considered even when three dimensional (3D) sound, in which there is currently a great deal of interest, is output through speakers, and when multi-channel sound signals are output through multiple speakers.

Conventional cross-talk cancellation technologies are classified into categories including off-line technology and real-time processing technology. With the continuous development of audio related functions, 3D sound or stereo sound has started to be applied to mobile phones or personal digital assistants (PDA). Because a size of a mobile communication terminal is limited, cross-talk cancellation technology that is suitable for a mobile device is applied using a speaker arrangement in an off-line fashion, or cross-talk cancellation technology is applied using a chip provided in a front end of a mobile communication speaker and operating in real time.

When the off-line technology is applied, a conventional cross-talk cancellation method individually processes sound source content and stores the processed content in a mobile memory. However, various audio content that is to be provided in the future must be processed on the basis of mechanical characteristics (e.g., a speaker arrangement or direction) of a mobile device. This processing significantly limits the availability of audio content.

Because of this limitation, a cross-talk cancellation process for all audio content, including ringtone data, cannot be applied in the off-line fashion according to the mechanical characteristics of various mobile devices. Therefore, desired stereo sound may not be provided to the listener, as compared with an original audio signal, when the listener listens to audio content from which cross-talk has been eliminated using an earphone.

Accordingly, at least two speakers are attached to various mobile communication systems, such as a mobile phone and a PDA, in order to provide a 2D/3D sound reproduction function. To provide a user with multi-channel sound, the cross-talk cancellation technology using a chip for the real-time process must be applied.

A cross-talk canceller operates in a front end of a speaker output unit. Conceptually speaking, a filter matrix for inverse filtering on cross-talk is applied. The cross-talk cancellation is described in greater detail with reference to FIG. 1.

FIG. 1 is a diagram illustrating the concept of cross-talk cancellation in a mobile communication system.

Referring to FIG. 1, left and right speakers 10a and 10b are connected to a cross-talk canceller 20 for eliminating cross-talk associated with left and right sound signals.

The cross-talk canceller 20 is configured in the form of a hardware chip, and performs modulation by adding to the input sound, an inverse signal of a cross-talk signal to be eliminated from a front end of an output unit of the speakers 10a and 10b. Accordingly, the listener can listen to an original signal from which the cross-talk signal has been eliminated.

A cross-talk cancellation filter is designed under an assumption that the cross-talk cancellation technology, based on the chip for the real-time process, works best when the listener is positioned between two speakers. This technology may obtain improved acoustic characteristics even when various conventional stereo sound signals are reproduced. However, an application of the cross-talk cancellation filter limits performance according to the mechanical characteristics of a mobile device. That is, the cross-talk cancellation filter is designed under an assumption that two stereo speakers are symmetrically arranged with respect to a position of the listener. However, it is difficult to achieve desired performance when the various speakers attached to a conventional mobile device are arranged in an asymmetrical direction or position.

Because the cross-talk cancellation process is implemented through the designed cross-talk cancellation filter and convolution with an input audio signal, the cross-talk cancellation filter must be redesigned on the basis of a speaker arrangement and direction of an associated mobile device in order to obtain the desired stereo effect. However, it is difficult for the conventional cross-talk cancellation process to achieve this considering the large number of existing limitations, such as an amount of computation and memory size associated with a cross-talk canceller provided in the form of a chip.

Accordingly, a need exists for a system and method for cross-talk cancellation that can be implemented without requiring the redesign of the cross-talk cancellation filter.

### SUMMARY OF THE INVENTION

It is, therefore, an aspect of the present invention to substantially solve the above and other problems, and to provide an apparatus and method for cross-talk cancellation that can maintain a conventional device by adjusting several control parameters without implementing a new cross-talk cancellation filter.

The above and other aspects of the present invention can be achieved by providing an apparatus for eliminating cross-talk occurring in a signal output through at least two speakers in a mobile system, comprising a decoder for decoding an input signal, a controller for providing information about a delay time difference between direct sound and cross-talk sound of the input signal and gain variation information, a cross-talk cancellation unit for receiving the delay time difference information and the gain variation information and eliminating cross-talk from the decoded signal received from the decoder, and an output unit for converting a stereo signal from which the cross-talk has been eliminated into an analog signal, and outputting the analog signal through the at least two speakers. The cross-talk cancellation unit comprises a stereo signal comparator for determining if an input audio signal is a mono audio signal or a pseudo stereo signal and computing a correlation of the pseudo stereo signal, a three dimensional (3D) sound phase extender for horizontally extending a sound phase of an output signal when the input audio signal is the pseudo stereo signal and increasing a spatial effect of sound, and a cross-talk canceller for eliminating the cross-talk from an output signal of the 3D sound phase extender.

The above and other aspects of the present invention can also be achieved by providing a method for eliminating cross-talk occurring in a signal output through at least two speakers in a cross-talk cancellation unit of a mobile system, comprising the steps of determining if an input audio signal is a mono audio signal or a pseudo stereo signal and computing a correlation of the pseudo stereo signal, horizontally extending a sound phase of an output signal if the input audio signal is the pseudo stereo signal and increasing a spatial effect of sound, extracting a low band signal when means for outputting a signal whose sound phase has been extended is a speaker, and eliminating cross-talk from an output signal of a three dimensional (3D) sound phase extender using delay time difference information and gain variation information.

### BRIEF DESCRIPTION OF THE DRAWINGS

The above and other aspects and advantages of the present invention will be more clearly understood from the following detailed description taken in conjunction with the accompanying drawings, in which:

FIG. 1 is a diagram illustrating the concept of cross-talk cancellation in a mobile communication system;

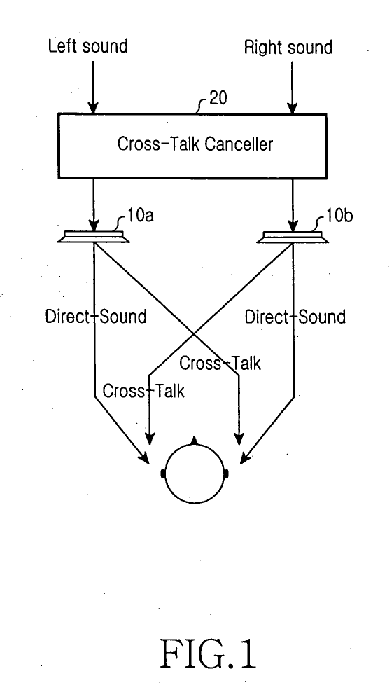

FIG. 2 is a block diagram illustrating an apparatus for cross-talk cancellation in accordance with an embodiment of the present invention;

FIG. 3 is a block diagram illustrating a cross-talk cancellation unit of FIG. 2 in accordance with an embodiment of the present invention; and

FIG. 4 is a flow chart illustrating a method for cross-talk cancellation in accordance with an embodiment of the present invention.

Throughout the drawings, like reference numerals will be understood to refer to like parts, components and structures.

### DETAILED DESCRIPTION OF THE EXEMPLARY EMBODIMENTS

A number of exemplary embodiments of the present invention will be described in detail herein below with reference to the accompanying drawings. In the following description, a detailed description of known functions and configurations incorporated herein will be omitted for clarity and conciseness.

Embodiments of the present invention comprise a cross-talk cancellation apparatus that is capable of being effectively applied to a mobile application, such as a mobile phone or personal digital assistant (PDA). Cross-talk sound influencing direct sound (such as from a speaker on the left or right side of a listener) occurs due to delay and signal gain attenuation of direct sound. In various mobile devices, a cross-talk cancellation process can be performed using a signal gain and delay time between the direct sound and the cross-talk sound. The following description illustrates an exemplary cross-talk cancellation apparatus in accordance with an embodiment of the present invention that can be flexibly applied to a mobile device using a signal gain and delay time between direct sound and cross-talk sound of a stereo signal according to a position of the listener and the mobile device.

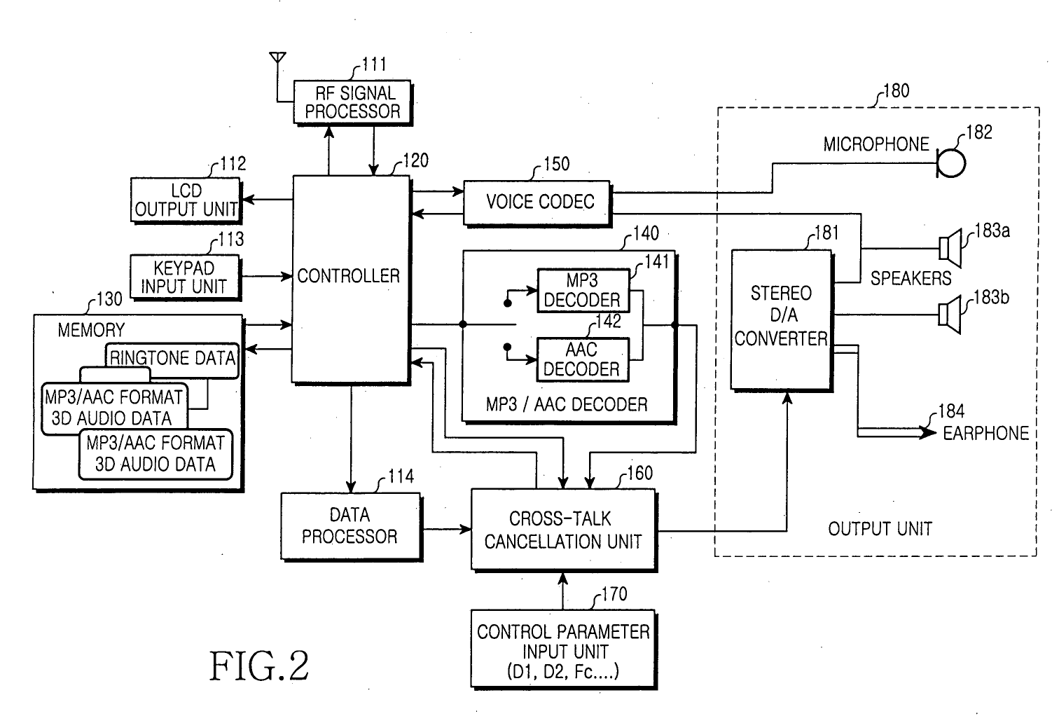

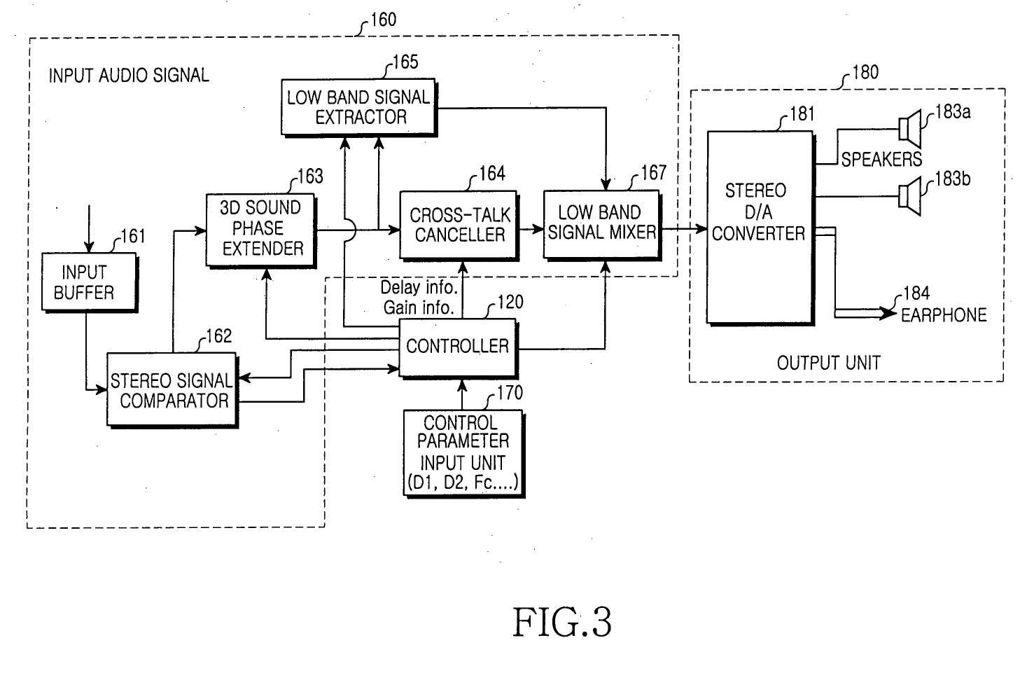

FIG. 2 is a block diagram illustrating an apparatus for cross-talk cancellation in accordance with an embodiment of the present invention, and FIG. 3 is a block diagram illustrating a cross-talk cancellation unit of FIG. 2 in greater detail. An exemplary embodiment of the cross-talk cancellation apparatus in a mobile device can be disposed before a speaker output unit or a stereo digital/analog (D/A) converter, and operates for audio signals to be output to the speakers.

Referring to FIG. 2, an exemplary embodiment of the cross-talk cancellation apparatus is comprised of a radio frequency (RF) signal processor 111 for processing an RF signal input from an antenna, a controller (modem chip) 120 for controlling the processed RF signal to be output, a memory 130 for storing ringtone data, Moving Picture Expert Group (MPEG) audio layer 3/advanced audio coding (MP3/AAC) format 3D audio data and so forth, a decoder 140 for decoding MP3 or AAC data, a voice codec 150, and a data processor (such as a SMAF format data processor) 114. The controller 120 is further connected to a liquid crystal display (LCD) output unit 112 and a keypad input unit 113. Moreover, the cross-talk cancellation apparatus is further comprised of a cross-talk cancellation unit 160 for eliminating cross-talk when left and right signals of an input stereo audio signal are very similar, and an output unit 180 for outputting an audio signal.

The decoder 140 is comprised of an MP3 decoder 141 for decoding the MP3 data, and an AAC decoder 142 for decoding the AAC data.

The cross-talk cancellation unit 160 is connected to a control parameter input unit 170, and receives parameters D1, D2, Fc, and so forth, (including for example, information about a position of a speaker attached to the mobile device and information about a distance between the mobile device and the listener) to be used for cross-talk cancellation. Moreover, the cross-talk cancellation unit 160 eliminates cross-talk from a stereo signal received from the decoder 140 according to a control operation of the controller 120.

The control parameter input unit 170 externally receives information about a position of a speaker attached to the mobile device, information about a distance between the mobile device and the listener, and so forth.

The output unit 180 is comprised of a stereo signal converter 181 for converting a digital stereo signal output from the voice codec 150 and the cross-talk cancellation unit 160 into an analog signal, and outputting the analog signal to speakers 183a and 183b and an earphone 184.

The voice codec 150 is connected to a microphone 182 and the stereo signal converter 181 included in the output unit 180, and converts a voice signal input through the microphone 182 to output the converted voice signal to the controller 120.

The cross-talk cancellation unit 160 of the above-described embodiment of the cross-talk cancellation apparatus will now be described in greater detail with reference to FIG. 3.

FIG. 3 is a block diagram illustrating the cross-talk cancellation unit 160 of FIG. 2 in greater detail.

Referring to FIG. 3, the cross-talk cancellation unit 160 is comprised of an input buffer 161 for temporarily storing an input audio signal, a stereo signal comparator 162 for identifying the input signal, a 3D sound phase extender 163 for creating the spatial effect of the audio signal, and a cross-talk canceller 164. Moreover, the cross-talk cancellation unit 160 is further comprised of a low band signal extractor 165 and a low band signal mixer 167.

When an audio signal is conventionally passed through a cross-talk cancellation apparatus, a low band signal is lost and an amount of listening sound is reduced, and a mono part of the signal is significantly reduced. This phenomenon is remarkable in a mobile communication terminal in which the distance between the two speakers is very close. Accordingly, a cross-talk cancellation algorithm adds an inverse phase signal to an opposite channel such that cross-talk can be cancelled when the listener listens to the audio signal. In this case, a result of the addition is output to the speaker.

The above-described phenomenon is very serious in the case of a mono signal in which left and right signal components are similar. To reduce the phenomenon, cross-talk cancellation strength is adjusted, and specifically, a mono signal needs to be converted into a pseudo stereo signal according to decorrelation. Returning to FIG. 3, the stereo signal comparator 162 computes a correlation of the input stereo signal, and sends reference information associated with the correlation to the controller 120, such that the 3D sound phase extender 163 can perform signal decorrelation and the cross-talk canceller 164 can adjust a cancellation level. The stereo signal comparator 162 determines a correlation level of the input audio signal received from the input buffer 161, or determines if the input audio signal is a mono audio signal. Then, the stereo signal comparator 162 outputs a signal based on the determination result to the stereo converter 181 and the 3D sound phase extender 163. Moreover, the stereo signal comparator 162 is further connected to the controller 120 of FIG. 2. The connection allows a control signal for cross-talk cancellation to be transmitted and received between the comparator 162 and the controller 120.

According to a control operation of the controller 120, the 3D sound phase extender 163 creates the spatial effect of an audio signal to be output to the speakers 183a and 183b using a head related transfer function associated with the determination signal, and outputs the audio signal to the cross-talk canceller 164.

Further, according to a control operation of the controller 120, the low band signal extractor 165 extracts a low band signal from an output signal of the 3D sound phase extender 163, and outputs the extracted low band signal to the low band signal mixer 167.

Still further, according to a control operation of the controller 120, the low band signal mixer 167 mixes the extracted low band signal from the low band signal extractor 165 with an output signal of the cross-talk canceller 164 and then outputs a result of the mixing to the stereo converter 181.

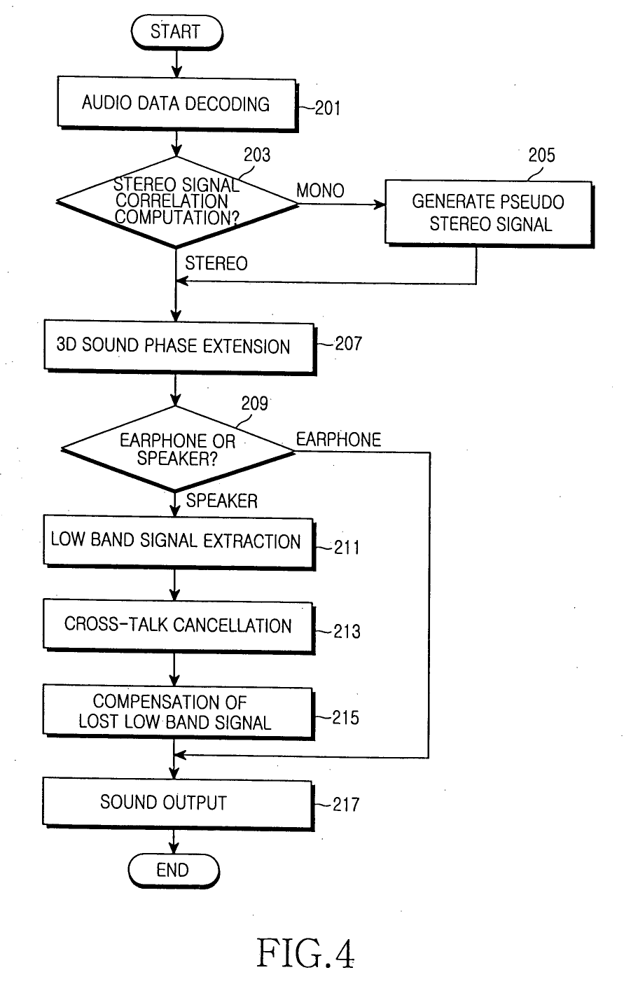

A method for cross-talk cancellation between direct sound and cross-talk sound in an embodiment of the cross-talk cancellation apparatus with the above-described structure will now be described in greater detail with reference to FIG. 4.

FIG. 4 is a flow chart illustrating a method for cross-talk cancellation in accordance with an embodiment of the present invention.

In step 201, the cross-talk cancellation unit 160 receives and temporarily stores audio signals (i.e., a ringtone signal passing through the decoder 140 and a Yamaha chip, and pulse code modulation (PCM) signals output from various audio decoders), in the input buffer 161. In step 203, the stereo signal comparator 162 computes stereo signal correlation to determine if an input audio signal is a mono audio signal or a stereo audio signal. If the input audio signal is a mono audio signal in the computation result, the mono audio signal is converted into a pseudo stereo signal according to decorrelation in step 205. The pseudo stereo signal is then transferred to step 207.

However, if the input audio signal is a stereo audio signal (or a converted pseudo stereo signal from step 205), the stereo signal comparator 162 computes a correlation between signals to be output to the left and right speakers, and outputs a pseudo stereo signal to the 3D sound phase extender 163 in step 207. However, an interval between the speakers may be significantly shortened according to the characteristics of a mobile device. When a pseudo stereo signal undergoes a theoretical cross-talk cancellation process, signal loss may occur and the quality of sound may be degraded. To compensate for the signal loss and sound quality degradation, the 3D sound phase extender 163 horizontally extends a sound phase of the pseudo stereo signal input from the stereo signal comparator 162 at step 207, thereby increasing the spatial effect of sound.

In step 209, a determination is made as to whether the sound of the phase extended in step 207 is output through the earphone or speaker. If the sound is output through the earphone, the method of FIG. 4 proceeds to step 217. If the sound is output through the speaker, the method of FIG. 4 proceeds to step 211. In step 211, the cross-talk cancellation unit 160 extracts a low band signal from an audio signal output from the 3D sound phase extender 163 through the low band signal extractor 165.

In step 213, the cross-talk cancellation unit 160 identifies a position or direction of the output speakers 183a and 183b, and a position relation between the speakers 183a and 183b and the listener on the basis of parameters input from the control parameter input unit 170. When the audio signal is output through the speakers 183a and 183b, the cross-talk cancellation unit 160 eliminates cross-talk between direct sound and cross-talk sound according to a delay time and a signal gain ratio computed for the stereo signal through the cross-talk canceller 164. The computed delay time is comprised of a delay time difference between the direct sound and the cross-talk sound. Information about the computed delay time and gain variation information, is then received from the controller 120.

In step 215, the cross-talk cancellation unit 160 performs compensation of an output audio signal capable of being lost, i.e., a lost low band signal, by mixing the extracted low band signal with the signal from which cross-talk has been eliminated, using the low band signal mixer 167. In this case, an extension degree of sound phase, a cutoff frequency of a low pass filter, a signal mixing ratio, and so on, are controlled through the controller 120. Additionally, the mobility of sound can be determined according to a head related transfer function applied to the 3D sound phase extender 163.

In step 217, the cross-talk cancellation unit 160 outputs a mixed signal from the low band signal mixer 167 to the stereo converter 181, such that a digital stereo signal from which cross-talk has been eliminated is output to the speakers 183a and 183b.

As noted above, a conventional cross-talk cancellation method requires the redesign of the cross-talk cancellation filter after measuring the paths of direct sound and cross-talk sound according to various types of speaker arrangements, and cannot perform a real-time process due to a significant amount of computation. As described above, embodiments of the present invention can easily apply a suitable real-time adjustment process to an associated mobile device by considering only a delay time difference between direct sound and cross-talk sound, gain variation, and a cutoff frequency of a low pass filter, as compared with the conventional cross-talk canceller.

A 3D sound phase extender that is capable of creating the effect of an audio signal, a compensation module for a low band signal, and a stereo signal comparator, can be arranged separately in the cross-talk cancellation unit. These components can be selectively operated through a controller such that they can be adjusted according to the listener's desire, and a cross-talk cancellation level and an amount of computation can be adjusted.

As compared with a conventional apparatus based on an off-line process, embodiments of the cross-talk cancellation apparatus can perform a real-time process, such that the listener can enjoy stereo sound of various audio content using speakers of a mobile device. When a mobile device is changed, embodiments of the cross-talk cancellation apparatus, unlike a conventional cross-talk canceller provided in the form of a chip, can maintain a conventional device by adjusting several control parameters without implementing a new cross-talk cancellation filter.

As is apparent from the above description, the present invention can easily apply a suitable real-time adjustment process to an associated mobile device by considering only a delay time difference between direct sound and cross-talk sound, gain variation, and a cutoff frequency of a low pass filter, as compared with a conventional cross-talk canceller. Moreover, the present invention can maintain a conventional device by adjusting several control parameters without implementing a new cross-talk cancellation filter.

Although a number of exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. An apparatus for eliminating cross-talk occurring in a signal output through at least two speakers in a mobile system, comprising:
a decoder for decoding an input signal;
a controller for providing information about a delay time difference between direct sound and cross-talk sound of the input signal and gain variation;
a cross-talk cancellation unit for receiving the information, eliminating cross-talk from the decoded signal received from the decoder, and compensating for a low band signal; and
an output unit for converting a stereo signal from which the cross-talk has been eliminated into an analog signal, and outputting the analog signal through the at least two speakers.

2. The apparatus of claim 1, further comprising:
a control parameter input unit for receiving control parameters for cross-talk cancellation.

3. The apparatus of claim 1, wherein the cross-talk cancellation unit comprises:
a stereo signal comparator for determining if an input audio signal is a mono audio signal or a stereo signal and if the input signal is a mono audio signal, converting the mono audio signal into a pseudo stereo signal;
a three dimensional (3D) sound phase extender for extending a sound phase of the stereo signal or the pseudo stereo signal; and
a cross-talk canceller for eliminating the cross-talk from an output signal of the 3D sound phase extender.

4. The apparatus of claim 3, further comprising:
a low band signal extractor for extracting a low band signal from the output signal of the 3D sound phase extender;
a low band signal mixer for mixing an output signal of the cross-talk canceller with the extracted low band signal; and
an input buffer for storing the input audio signal.

5. A method for eliminating cross-talk occurring in a signal output through at least two speakers in a cross-talk cancellation unit of a mobile system, comprising the steps of:
determining if an input audio signal is a mono audio signal or a stereo signal;
converting the mono audio signal into a pseudo stereo signal if the input signal is a mono audio signal;
extending a sound phase of the stereo signal or the pseudo stereo signal;
eliminating cross-talk from the extended signal using delay time difference information and gain variation information;
determining an output means and extracting a low band signal when the means for outputting a signal whose sound phase has been extended is a speaker; and
compensating for a lost low band signal using the extracted low band signal.

6. The method of claim 5, wherein the step of compensating for the lost low band signal further comprises the steps of:
mixing a signal output from a cross-talk canceller with the extracted low band signal.

7. A method for eliminating cross-talk occurring in a signal output through at least two speakers in a cross-talk cancellation unit of a mobile system, comprising the steps of:
receiving and storing audio signals;
computing a stereo signal correlation to determine if an input audio signal is a mono audio signal or a stereo audio signal, and if the input audio signal is a mono audio signal, converting the mono audio signal into a pseudo stereo signal; and
extending a sound phase of the stereo signal or the pseudo stereo signal and outputting the extended signal via a speaker or an earphone.

8. The method of claim 7, further comprising the steps of:
determining whether the sound is output through the earphone or speaker and, if the sound is output through the speaker, extracting a low band signal from the audio signal output;
identifying a position of the output speakers and a listener on the basis of input parameters; and
eliminating cross-talk between direct sound and cross-talk sound according to a delay time and a signal gain ratio, wherein the computed delay time is comprised of a delay time difference between the direct sound and the cross-talk sound.

9. The method of claim 8, further comprising the steps of:
performing a compensation of an output audio signal by mixing the extracted low band signal with the signal from which cross-talk has been eliminated; and
outputting a mixed signal such that a digital stereo signal from which cross-talk has been eliminated is output to the speakers.
